(19) United States
(12) Patent Application Publication
(10) Pub. No.: US 2012/0315007 A1
(43) Pub. Date: Dec. 13, 2012

(54) IMAGING APPARATUS AND CONTROL METHOD THEREFOR

(75) Inventor: Koji Yoshida, Fujisawa-shi (JP)

(73) Assignee: CANON KABUSHIKI KAISHA, Tokyo (JP)

(21) Appl. No.: 13/487,972

(22) Filed: Jun. 4, 2012

(30) Foreign Application Priority Data
Jun. 8, 2011 (JP) 2011-128501

(51) Int. Cl. H04N 5/77

(52) U.S. Cl. 386/224; 386/E05.069

(57) ABSTRACT

An imaging apparatus and control method that allow users to recognize when switching of files will occur during an image recording session in a case where a size of a recording file currently being recorded to reaches a predetermined size. During recording of a moving image, when the size of a recording file reaches a first size, a notice about recording is going to be switched to another recording file is provided.

### BACKGROUND OF THE INVENTION

1. Field of the Invention

The present invention relates to an imaging apparatus, a control method for the imaging apparatus, and a storage medium, and particularly relates to a suitable technique for capturing a moving image.

2. Description of the Related Art

Among imaging apparatuses, there are some imaging apparatuses that can continuously capture a moving image by switching the current recording file to another recording file during image-capturing. Japanese Patent Application Laid-Open No. 2009-33246 discusses a recording apparatus that continues image-capturing without interruption by generating a new file when the current file size reaches a predetermined size during image-capturing.

However, in the technology discussed in Japanese Patent Application Laid-Open No. 2009-33246, since prior notice of switching of files is not provided, a user is unable to know in advance when files are switched.

### SUMMARY OF THE INVENTION

An aspect of the present invention is directed to an imaging apparatus and control method intended to allow a user to know in advance that the recording file is going to be switched to a new file when the file reaches a predetermined file size during image-capturing of a moving image so that the image-capturing of the moving image can be continued.

According to an aspect of the present invention, an imaging apparatus includes a memory, and a system control unit configured to capture a moving image to generate moving image data, record the moving image data to at least a first recording file on a recording medium, wherein when a size of the first recording file reaches a first size, stop recording to the first recording file, and start recording to a second recording file, and display, when the size of the first recording file reaches a second size smaller than the first size, a notice about recording will be switched from the first recording file to the second recording file before recording is switched to the second recording file.

According to embodiments of the present invention, when the file reaches a predetermined file size during image-capturing of a moving image, before a new file is generated, a user can know in advance that the current recording file will soon be switched to a new file.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of an external structure of a digital camera according to an exemplary embodiment of the present invention.

FIG. 2 is a block diagram illustrating an example of an internal structure of the digital camera according to an exemplary embodiment of the present invention.

FIGS. 3A and 3B depict a flowchart illustrating an example of an operation procedure for displaying a prior notice of switching files before a current recording file is switched to another file during image-capturing of a moving image according to an exemplary embodiment of the present invention.

FIGS. 4A and 4B illustrate examples of display screen before and after start of recording of a moving image.

FIGS. 5A and 5B are diagrams illustrating examples of the display screen before the start of recording of a moving image, including time lines.

FIG. 6 is a diagram illustrating an example of a display screen indicating that the captured moving image have been divided and recorded in two or more files.

FIG. 7 is a diagram illustrating an example of a setting screen for setting a recording level.

### DESCRIPTION OF THE EMBODIMENTS

Various exemplary embodiments, features, and aspects of the invention will be described in detail below with reference to the drawings.

It is to be noted that the following exemplary embodiment is merely one example for implementing the present invention and can be appropriately modified or changed depending on individual constructions and various conditions of apparatuses to which the present invention is applied. Thus, the present invention is in no way limited to the following exemplary embodiment.

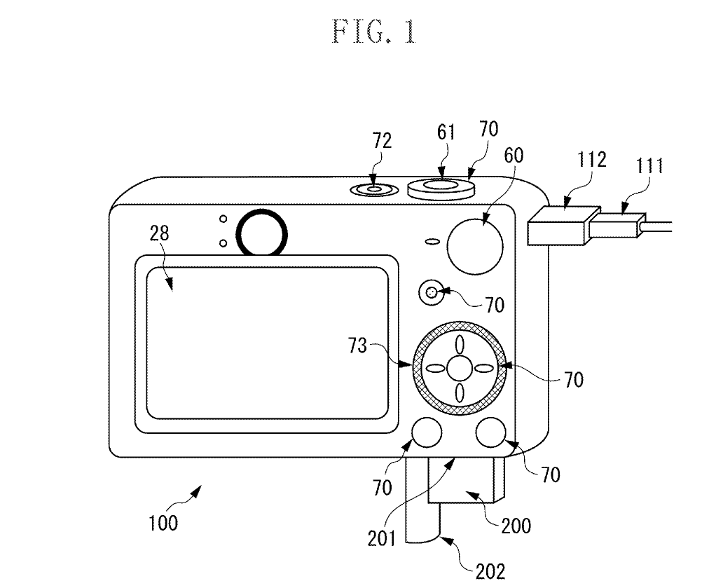

FIG. 1 is a diagram illustrating an external structure of a digital camera 100 as an example of an imaging apparatus according to an exemplary embodiment of the present invention.

In FIG. 1, a display unit 28 displays images and various kinds of information. A shutter button 61 is an operation member used to issue an instruction to take a picture. A mode changing switch 60 is an operation member used to switch various modes. A connector 112 is a connector for connecting a connection cable and the digital camera 100.

An operation unit 70 includes operating members, such as various types of switches, buttons, and a touch panel, which are used to accept various input operations from a user. A touch wheel 73 on the operation unit 70 is a touch-input operation member configured to input selected items jointly with direction buttons. The touch wheel 73 consists of touch sensors, and does not itself turn, but rather detects, for example, the turning motion(s) of a user's finger(s).

A power supply switch 72 turns the power supply on and off. A recording medium 200 is a storage device, such as a memory card or a hard disk. A recording medium slot 201 is a slot to accommodate the recording medium 200. The recording medium 200, when inserted into the recording medium slot 201, can communicate with the digital camera 100. A lid 202 acts as a cover for the recording medium slot 201.

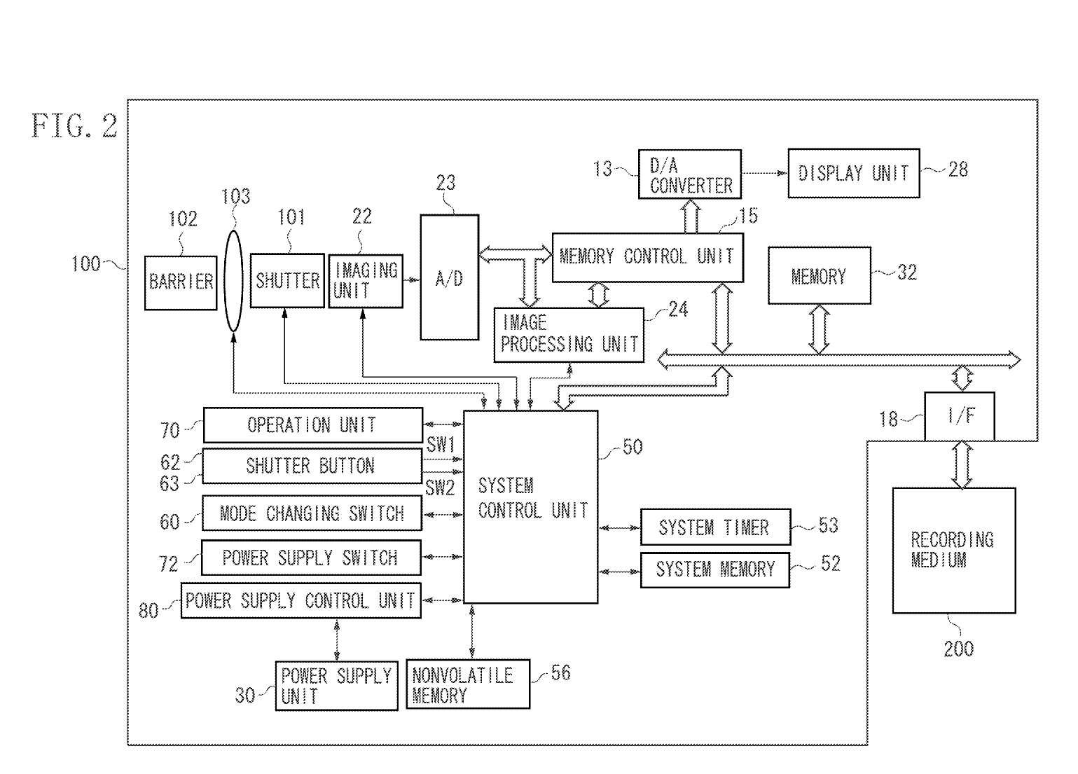

FIG. 2 is a block diagram illustrating an example of an internal structure of the digital camera 100 according to the present exemplary embodiment of the invention.

In FIG. 2, an imaging lens 103 is formed by a set of lenses, including a zoom lens and a focusing lens. A shutter 101 includes a diaphragm function. An imaging unit 22 is an image sensor including CCD sensor or MOS sensor.

An A/D converter 23 converts an analog signal output from the imaging unit 22 into a digital signal.

A barrier 102 covers an imaging system including the imaging lens 103 of the digital camera 100. The barrier 102 prevents the imaging system 100, which includes the imaging lens 103, the shutter 101, and the imaging unit 22, from being stained or damaged.

An image processing unit 24 performs a predetermined pixel interpolation and resizing processing for reducing image size, and also a color conversion operation on a digital signal (image data) output from the A/D converter 23 or data output from a memory control unit 15

The image processing unit 24 performs a predetermined arithmetic processing using captured image data. A system control unit 50 controls exposure and distance measuring based on the results obtained from the arithmetic processing. Thus, through-the-lens auto-focusing (TTL-AF), auto exposure (AE), and flash pre-emission for flash exposure (FE) are executed.

The image processing unit 24 further performs a predetermined arithmetic processing by using captured image data, and also performs TTL-type auto white balance (AWB) processing based on the results obtained from the arithmetic processing.

The digital signal (image data) output from the A/D converter 23 is written in a memory 32 through the image processing unit 24 and the memory control unit 15 or through the memory control unit 15.

The memory 32 stores image data obtained by the imaging unit 22 and converted by the A/D converter 23 into digital data, and also stores image data to be displayed on the display unit 28. The memory 32 has a sufficient capacity to store a predetermined number of still images, a predetermined time period of moving image data, and audio data.

The memory 32 also serves as a memory for image display (video memory). A D/A converter 13 converts data stored in the memory 32 for image display into an analog signal, and supplies the signal to the display unit 28. The image data for display written in the memory 32 are displayed by the display unit 28 via the D/A converter 13.

The display unit 28 displays an image on an LCD display screen, for example, according to the analog signal supplied from the D/A converter 13. The digital signal obtained via the A/D converter 23 and stored in the memory 32 is converted into an analog signal by the D/A converter 13. The display unit 28 can display a through-image by sequentially transferring the analog signals to the display unit 28, which functions as an electronic viewfinder.

A non-volatile memory 56 is an electrically erasable and recordable memory, and an EEPROM memory may be used, for example. The non-volatile memory 56 stores constants and a program for operating the system control unit 50. The program is a program for implementing various flowcharts in the present exemplary embodiment, which are described below.

The system control unit 50 controls the digital camera 100. Various kinds of processing according to the present exemplary embodiment can be implemented by executing a program recorded in the non-volatile memory 56 described above. The system control unit 50 controls a display operation by controlling the memory 32, the D/A converter 13, and the display unit 28.

A RAM is employed as a system memory 52. Constants and variables used to operate the system control unit 50 and a program read out from the non-volatile memory 56 are loaded in the RAM. A system timer 53 is a time measuring unit for measuring time used for various kinds of controls and also measuring time of a built-in clock.

A mode changing switch 60, a first shutter switch 62, a second shutter switch 63, and an operation unit 70 are operation members for inputting operation instructions to the system control unit 50.

The mode changing switch 60 switches the operation mode of the system control unit 50 to a “still-image recording mode”, a “moving-image recording mode”, and a “reproducing mode”. The modes included in the “still-image recording mode” are an “auto image-capturing mode”, an “auto scene determination mode”, a “manual mode”, various scene modes, which are settings for various scenes, respectively, a “program AE mode”, and a “custom mode”.

The mode changing switch 60 allows the user to switch the operation mode directly to any of the modes included in the “still-image recording mode”. The user may set the mode changing switch 60 to the “still-image recording mode”, then switch the operation mode to a desired mode included in the “still-image recording mode” by using another operation member. Similarly, the “moving-image recording mode” may include a plurality of modes.

The first shutter switch 62 is turned ON when the shutter button 61 on the digital camera 100 is half-depressed (an instruction to prepare for image-capturing), and a first shutter switch signal SW1 is generated. When the first shutter switch signal SW1 is input to the system control unit 50, the operations start, such as the auto focusing (AF) processing, the auto exposure (AE) processing, the auto white balance (AWB) processing, and the flash pre-emission for flash exposure (FE) processing.

The second shutter switch 63 is turned ON when the shutter button 61 is fully pressed to the end position of the switch operation, and a second shutter switch signal SW2 is issued. When the second shutter switch signal SW2 is input to the system control unit 50, a series of operations of image-capturing processing are started, from reading a signal from the imaging unit 22 up to writing image data on the recording medium 200.

The operation members on the operation unit 70 are assigned functions depending on situations when the user selects and operates various function icons displayed on the screen of the display unit 28, which serve as function buttons. The function buttons include an end button, a return button, an image feed button, a jump button, a narrow button, and an attribute change button.

For example, when a menu button is pressed, the display unit 28 displays a menu screen on which various settings can be performed. The user can intuitively perform various settings on the menu screen appearing on the display unit 28 by using four (up, down, left, and right) direction buttons and a set button.

When the touch wheel 73 illustrated in FIG. 1 is touch-operated, an electric pulse signal is generated according to the touch operation, and based on the pulse signal, the system control unit 50 controls various parts of the digital camera 100.

From the pulse signal, it is possible to determine the direction in which the touch wheel 73 is touch-operated and a number of rotations of the touch wheel 73. The touch wheel 73 may be any operation member so long as the touch operation can be detected.

A power supply control unit 80 includes a battery detection circuit, a DC-DC converter, and a switching circuit to switch blocks to which power is supplied. The power supply control unit 80 detects a type of a battery, remaining battery level, and whether a battery is mounted or not. According to a detection result and an instruction from the system control unit 50, the power supply control unit 80 controls the DC-DC converter and supplies necessary voltage to various parts, including the recording medium 200 for a required period of time.

A power supply unit 30 includes a primary battery, such as an alkali or a lithium battery, a secondary battery, such as a NiCd battery, a NiMH battery, and a Li battery, or an AC adapter. A recording medium interface (I/F) 18 is an interface with the recording medium 200, such as a memory card or a hard disk. The recording medium 200 may be a memory card for recording image data captured by image-capturing. The recording medium 200 may be a semiconductor memory or a magnetic disk.

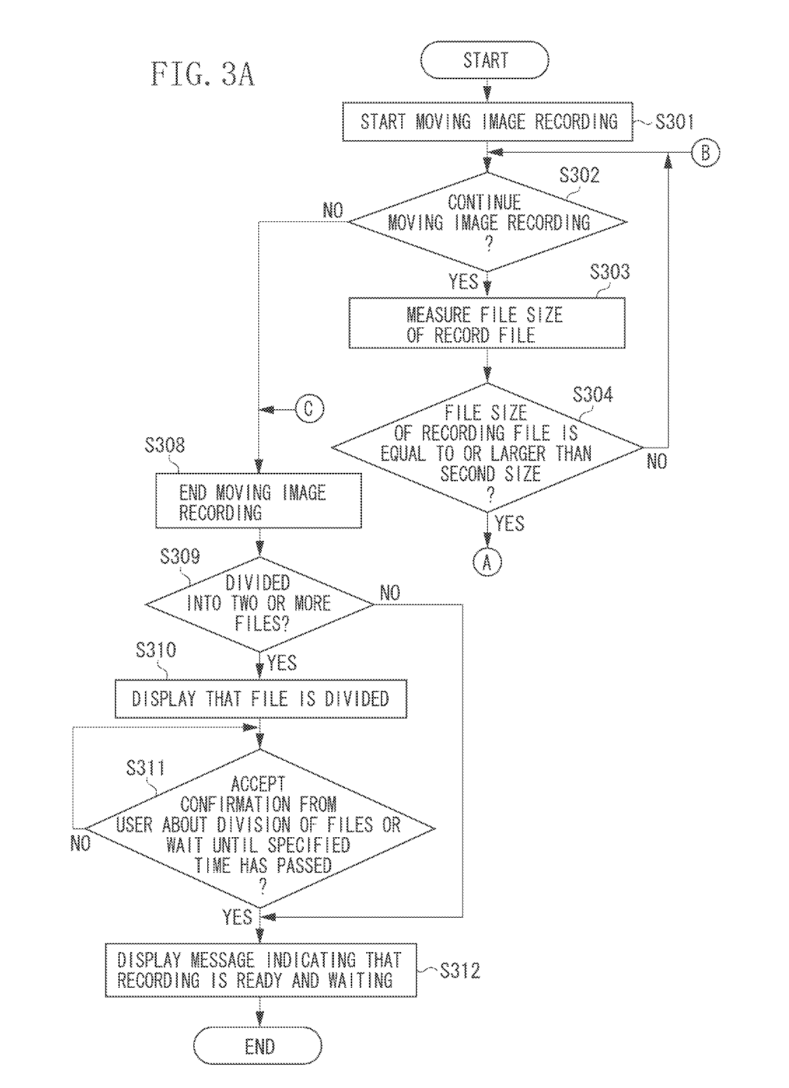

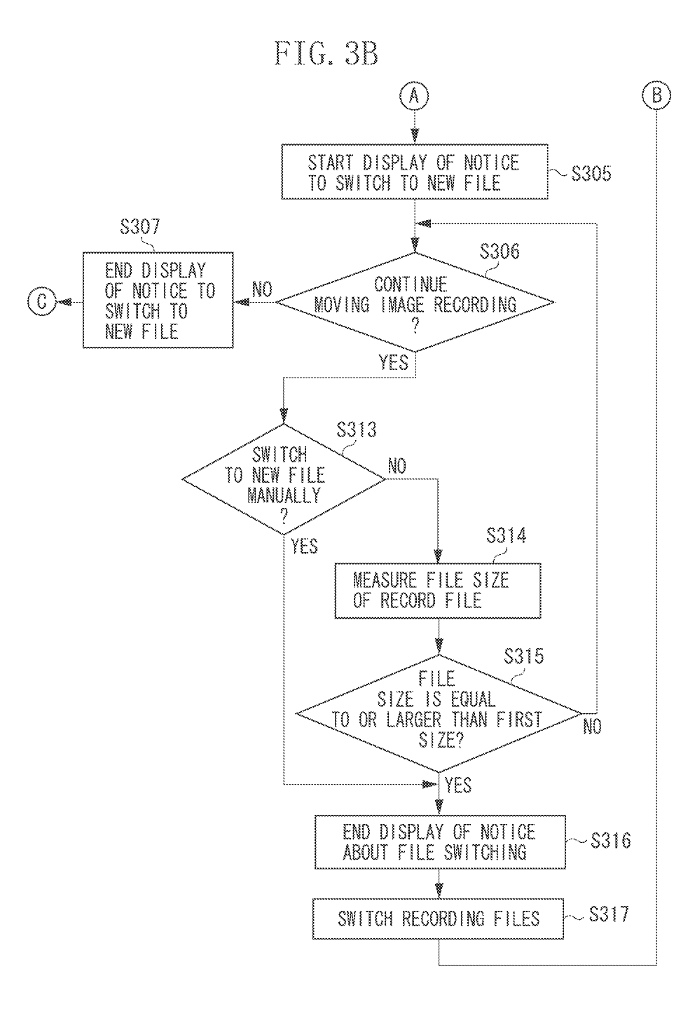

FIG. 3 is a flowchart illustrating an example of an operation procedure of displaying a prior notice of switching of files before a current recording file is switched to another recording file during image-capturing of a moving image according to the present exemplary embodiment. The flowchart in FIG. 3 is implemented when the program recorded in the non-volatile memory 56 is read into the system memory 52 and executed by the system control unit 50.

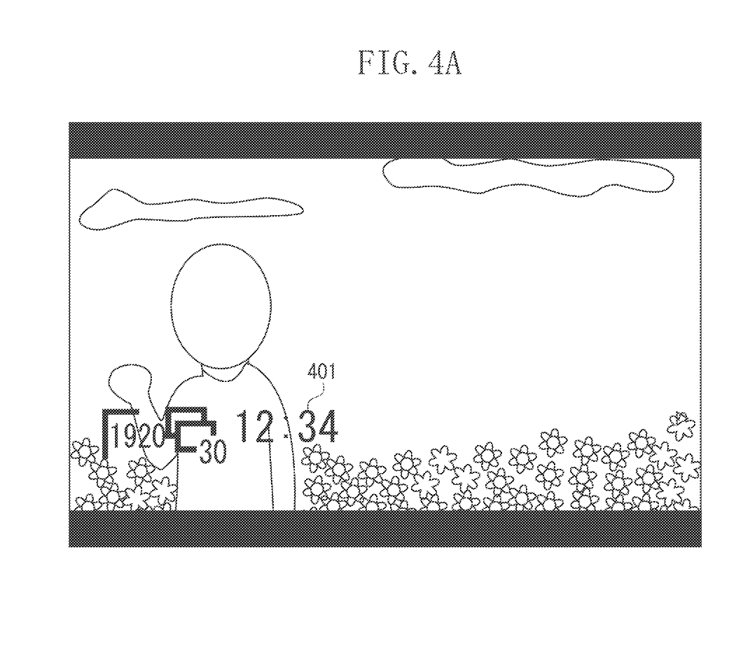

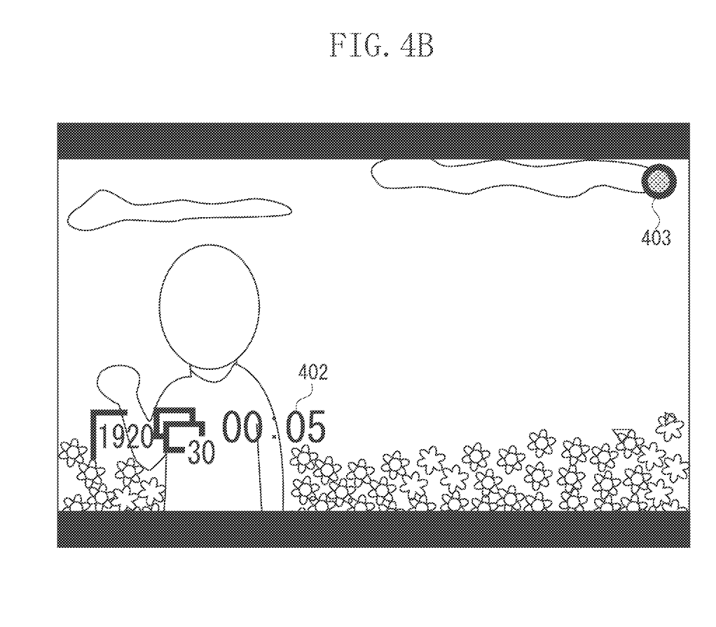

FIG. 4A is a diagram illustrating an example of a display screen before moving image recording is started. The screen in FIG. 4A displays a recordable time period 401 on the recording medium 200 under the current settings for moving image recording.

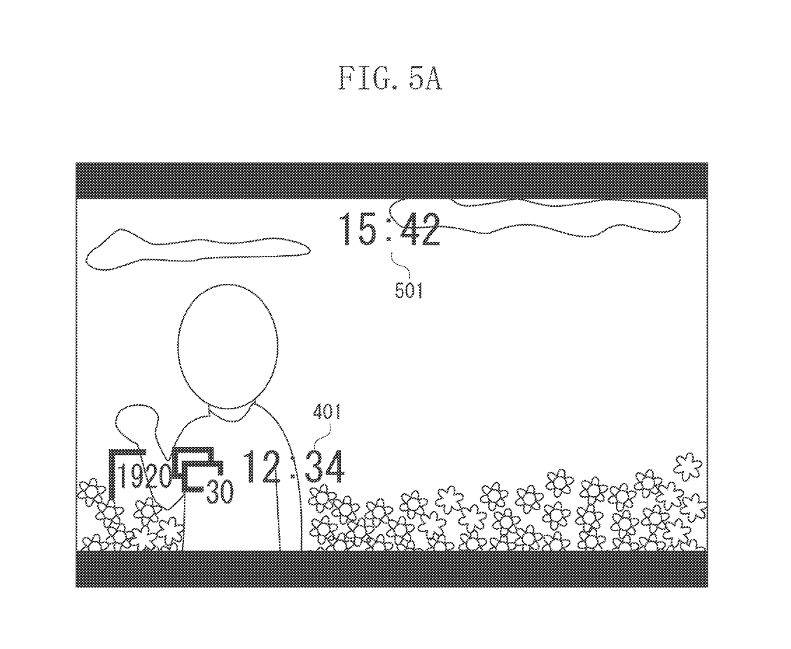

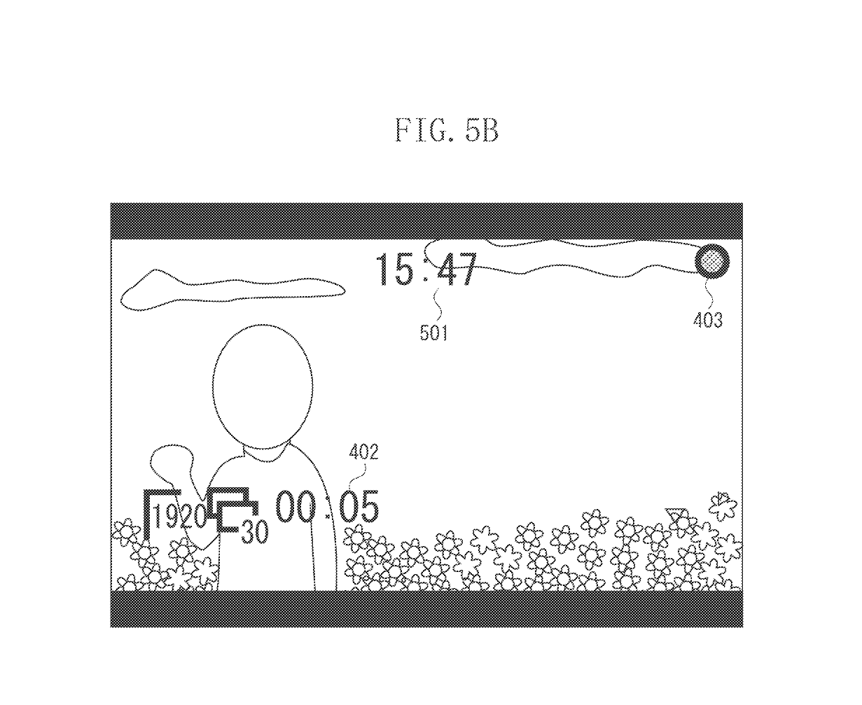

FIG. 5A is a diagram illustrating an example of a display screen, including a time code, before moving image recording is started. As illustrated in FIG. 5A, when a time code is displayed, a time code 501 is displayed at an upper position of the display screen.

In FIG. 3, when the system control unit 50 receives an instruction to start moving image recording from the operation unit 70, the processing in FIG. 3 is started, and in step S301, moving image recording is started.

More specifically, the system control unit 50 generates a recording file on the recording medium 200. A signal input from the imaging unit 22 is processed by the A/D converter 23 and the image processing unit 24. The processed image data is recorded to the recording file. At this time, as information about the recording file generated on the recording medium 200, information about items such as a file name and an address on the recording medium 200 is recorded in the system memory 52.

When moving image recording is started, the system control unit 50 displays recording time (time elapsed since the start of recording) on the display unit 28. FIG. 4B is a diagram illustrating an example of a display screen after the start of moving image recording. As illustrated in FIG. 4B, on a display screen, recording time 402 is displayed and also a moving image recording mark 403 is displayed at the upper right corner of the screen.

FIG. 5B is a diagram illustrating an example of a display screen including a time code after the start of moving image recording. As illustrated in FIG. 5B, on a display screen, a time code 501 is displayed at the upper center of the display screen, and also a recording time 402 is displayed on the lower left of the display screen. A moving image recording mark 304 is displayed at the upper right corner of the display screen.

Time codes can be divided into two kinds. One is referred to as a “REC RUN” time code. In this case, a time code denotes a cumulative recording time period of a plurality of moving images recorded after the user sets the “REC RUN” to zero. FIG. 5B illustrates an example of display of a “REC RUN” time code, and indicates a case where the cumulative recording time of moving images captured after the user sets the REC RUN to zero is 15 minutes 47 seconds.

The second is referred to as a “FREE RUN” time code. The “FREE RUN” time code denotes an actual time counted by the system timer 53 regardless of whether a moving image is being recorded or not. In the present exemplary embodiment, the time code 501 can be set whether to display actual time just like an ordinary clock or to display a cumulative recording time counted from when the time code is reset to zero. The time code is recorded as attribute information of a recorded moving image.

In step S302, the system control unit 50 determines whether it has received an instruction of a termination operation of the moving image recording from the operation unit 70. If it is determined that the system control unit 50 has not received an instruction to terminate moving image recording and continues the moving image recording (YES in step S302), the processing proceeds to step S303. If it is determined that the system control unit 50 has received an instruction to terminate the moving image recording and terminates the moving image recording (NO in step S302), the processing proceeds to step S308.

In step S303, the system control unit 50 measures a file size of the recording file. In step S304, the system control unit 50 determines whether the file size of the recording file has reached a second size smaller than a first size (i.e., the upper limit of a single recording file). If it is determined that the file size of the recording file has reached the second size (YES in step S304), the processing proceeds to step S305. If it is determined that the file size of the recording file has not reached the second size (NO in step S304), the processing returns to step S302.

The first size is a capacity as a threshold value for switching the recording file to a new file, and therefore indicates a maximum management capacity of the file system, for example. The second size is a capacity as a threshold value for displaying a prior notice of switching of files.

In the present exemplary embodiment, when the file size of the recording file has reached the second size, this means that the recording file is coming close to the first size. Therefore, a notice is issued that the current recording file will soon be switched to a new file.

The second size is set based on the current settings for moving image recording such as an image size (a number of pixels), recording method, a compression rate, and a frame rate.

For example, by calculating a second size so that a recording time period corresponding to a difference between the first size and the second size is equal to a predetermined time period, the time period left until reaching the first size can be fixed, and in this fixed time period, a prior notice about switching can be started. In this case, the second size is a file size estimated that the remaining time until reaching the first size is equal to the predetermined time period.

In step S305, the system control unit 50, for example, causes the display unit 28 to display a prior notice about switching by blinking a recording time or a time code. In FIG. 4B, the recording time 402 is blinking and in FIG. 5B, the time code 501 is blinking.

Instead of blinking a recording time or time code, a guidance or an icon may be displayed in a manner that expressly indicates that the current recording file is going to be switched to a new file. In another exemplary embodiment, a guidance or icon may be displayed together with blinking the recording time or time code.

In step S306, the system control unit 50 determines whether an instruction to perform a termination operation of moving image recording has been received from the operation unit 70. If it is determined that an instruction to perform a termination operation of moving image recording has not been received and moving image recording is continued (YES in step S306), the processing proceeds to step S313. If it is determined that an instruction to perform a termination operation of moving image recording has been received and moving image recording is terminated (NO in step S306), the processing proceeds to step S307.

In step S307, the system control unit 50 terminates display of the recording file switching notice on the display unit 28. For example, the recording time 402 in FIG. 4B and the time code 501 in FIG. 5B cease to blink.

In step S308, the system control unit 50 ends a series of operations in moving image recording. In step S309, the system control unit 50 refers to information about the recording files stored in the system memory 52. And, the system control unit 50 determines whether the moving image recorded in the current recording are divided into two or more files. If it is determined that the moving image recorded in the current recording are divided into two or more files (YES in step S309), the processing proceeds to step S310. Otherwise (NO in step S309), the processing proceeds to step S312.

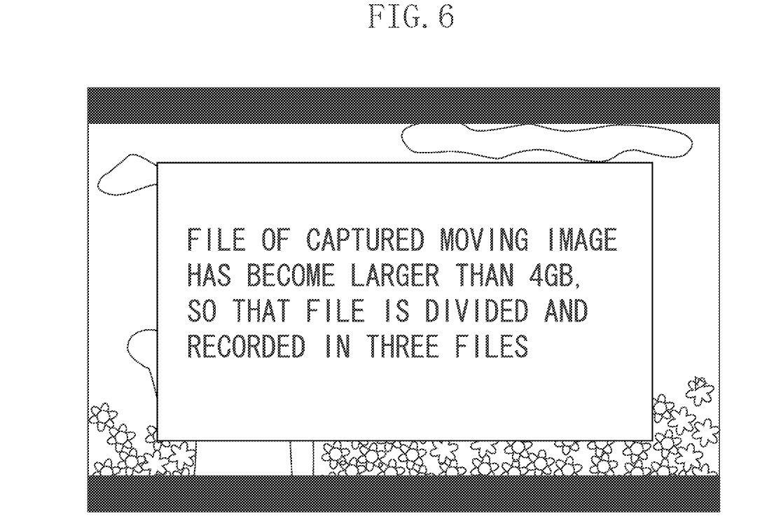

In step S310, the system control unit 50 displays on the display unit 28 that the moving image captured by the current recording are divided into two or more file. FIG. 6 illustrates an example of the display screen displaying that the moving image captured in the current recording are divided into two or more files.

By looking at the screen image like one illustrated in FIG. 6, the user can recognize that the image captured by the current recording is divided into two or more files. If the user wants to check the image taken by the current image-capturing, the user can determine that it is necessary to see some preceding files in addition to the recent video files.

In step S311, the system control unit 50 accepts an input operation on the operation unit 70 to notify that the user confirmed the screen image displayed in step S310, or waits until a predetermined time (e.g., a few seconds) has passed. After having accepted the confirmation operation or when the predetermined time has passed (YES in step S311), the system operation unit 50 terminates the display started in step S311. Then, the processing proceeds to step S312.

In step S312, the system control unit 50 displays on the display unit 28 that moving image recording is ready and waiting, just like in the display screen before the start of video recording, and then, completes the processing. More specifically, the screen images, illustrated in FIGS. 4B and 5B, are displayed again.

If a message that the moving image captured currently is divided into two or more files is not displayed, the display unit 28 again displays a recordable time 401 and the moving image recording mark 403 is turned off.

In step S313, the system control unit 50 determines whether an instruction to perform an operation to switch recording files has been received from the operation unit 70. If it is determined that an instruction to perform the recording file switching operation has not been received (NO in step S313), the processing proceeds to step S314. If an instruction to perform the recording file switching operation has been received (YES in step S313), the processing proceeds to step S316.

In step S314, the system control unit 50 measures a file size of the recording file. In step S315, the system control unit 50 determines whether the file size of the recording file has reached the first size discussed above. If it is determined that the file size of the recording file has reached the first size (YES in step S315), the processing proceeds to step S316. If it is determined that the file size of the recording file has not reached the first size (NO in step S315), the processing returns to step S306.

In step S316, the system control unit 50 terminates the notice about switching one of the files on the display unit 28. In a case illustrated in FIG. 4B, the recording time 402 ceases to blink. In a case illustrated in FIG. 5B, the time code 501 ceases to blink.

In step S317, the system control unit 50 generates a new recording file in the recording medium 200. The system control unit 50 stops writing to the current recording file, and starts to record image data to the new recording file. Then, the processing returns to step S302.

As information about the new recording file on which recording of moving images has been started, information including a filename and addresses in the recording medium 200, is stored in the system memory 52. In this manner, information about the files before and after the switching of the files is held in the system memory 52. Therefore, from the information held in the system memory 52, it can be recognized how many recording files are used to divide the currently captured moving image into. In addition, it can be also recognized therefrom which recording files are used.

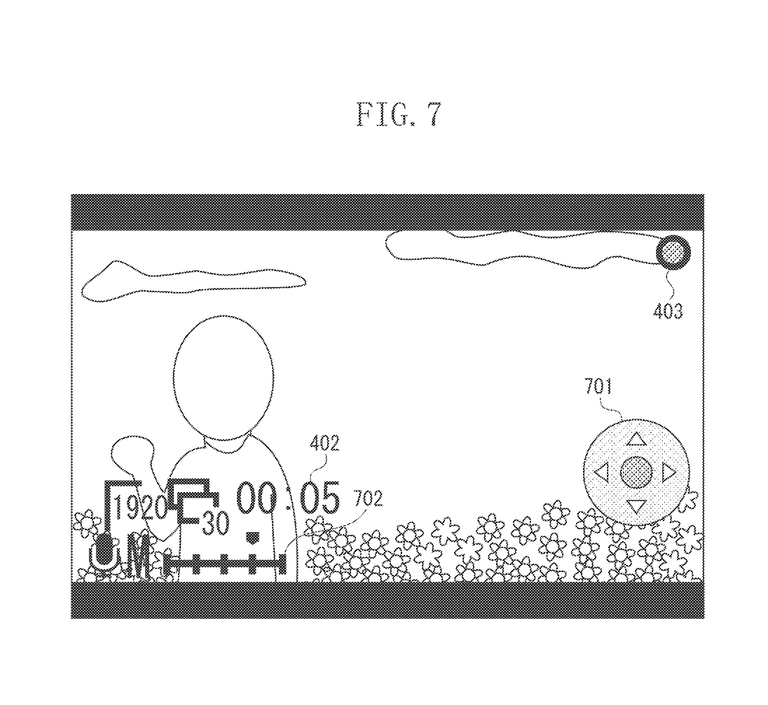

An audio recording level can be set during video recording. The audio recording level is set by operating the touch wheel 73. As illustrated in Fig. FIG. 7, the audio recording level may be set by displaying a touch wheel icon 701 and an audio recording level 702.

As described above, according to the present exemplary embodiment, prior notice of switching to a new file is displayed when the current file size has reached the second size before the file size reaches the first size of the recording file during moving image recording and a recording file is generated.

The above arrangement provides user with the ability to recognize that the current recording file will be soon switched to a new file before switching of files actually occurs during recording of the moving image. Therefore, in a case where it is desired to prevent complication of file management caused by an increase of files, after displaying a prior notice of switching of files is started, and before the recording files are switched, by terminating recording of moving images, an inadvertent increase in the number of recording files can be prevented.

Moreover, while a notice of switching of files is being displayed, the user can issue an instruction to switch files at an intended timing.

In the present exemplary embodiment, when the file size of the recording file under recording has reached the first size, recording is continued by switching the current file to a new file. In another embodiment, moving image recording can be continued by switching recording files for other reasons.

For example, in some cases, when a moving image is uploaded to a server, an upper limit of recording time period of a moving image per file is limited to a predetermined time period (first time period). In this case also, when the recording time of a moving image per file has reached the first time, the recording files are switched and recording is continued on a new file.

In each processing illustrated in FIG. 3, similar effects of the above described embodiments can be obtained by replacing the recording file size by a recording time period, a first size by a first time period, the second size by a second time period shorter than the first time period.

In yet another embodiment, relay recording is performed by dividing a moving image into a plurality of recording media. The relay recording is a recording method which enables recording to be continued by switching recording media from a first recording medium to a second recording medium when a remaining capacity of the first recording medium becomes less than a predetermined capacity (the first capacity) while recording in the first recording medium.

In the relay recording, when the remaining capacity of the first recording medium becomes equal to or smaller than the second capacity (which is larger than the first capacity) and is going to be still smaller than the first capacity, a prior notice of switching of files is started. In this case, the digital camera 100 in FIG. 1 includes a hardware structure capable of recording a moving image not only to the recording medium 200 but also to other recoding media, such as a built-in memory and a memory card.

In step S303 and step S314 in FIG. 3, the system control unit 50 measures a remaining capacity in the recording medium under recording instead of file size. In step S304, the system control unit 50 determines whether the remaining capacity of the recording medium under recording is less than or equal to the second capacity, and in step S315, the system control unit 50 determines whether the remaining capacity of the recording medium under recording is less than or equal to the first capacity. In step S317, the recording file is switched to another recording medium. With this method, recording can be implemented by relay recording in a similar way as in the above-described exemplary embodiment.

Control by the system control unit 50 may be executed by using a single piece of hardware, or the entire system may be controlled by a plurality of pieces of hardware sharing the processing.

The present invention has been described in detail according to exemplary embodiments. However, the present invention is not limited to the above-described embodiments, but may be embodied in many different forms without departing from the spirit and scope of the present invention.

In the above-described exemplary embodiments, the present invention is applied to a digital camera, but the above-described embodiments are not limited to this example, and may be applied to imaging apparatuses capable of capturing moving images, such as camera-equipped personal computers, camera-equipped personal digital assistants (PDAs), camera-equipped mobile phones, camera-equipped music players, camera-equipped game machines, and camera-equipped electronic book readers.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-128501 filed Jun. 8, 2011, which is hereby incorporated by reference herein in its entirety.

What is claimed is:

1. An imaging apparatus comprising:
a memory; and
a system control unit configured to:
capture a moving image to generate moving image data;
record the moving image data to at least a first recording file on a recording medium, wherein when a size of the first recording file reaches a first size, stop recording to the first recording file and start recording to a second recording file; and
display, when the size of the first recording file reaches a second size that is smaller than the first size, a notice about recording will be switched from the first recording file to the second recording file before recording is switched to the second recording file.

2. The imaging apparatus according to claim 1, wherein, when the size of the first recording file has reached the first size, the system control unit terminates displaying the notice.

3. The imaging apparatus according to claim 1, wherein the first size is a maximum management capacity of a file system.

4. The imaging apparatus according to claim 1, wherein the second size is a file size determined so that a remaining time period until the file reaches the first size becomes a predetermined time period.

5. The imaging apparatus according to claim 1, wherein the system control unit displays the notice by causing a recording time period being displayed to blink.

6. The imaging apparatus according to claim 1, wherein the system control unit displays the notice by causing a time code being displayed to blink.

7. The imaging apparatus according to claim 1, further comprising an operation unit configured to issue an instruction to switch recording files for recording moving image data,
wherein, while the notice is being displayed, when receiving the instruction, the system control unit stops recording to a recording file currently being used and begins recording to another recording file before the size of the recording file reaches the first size.

8. An imaging apparatus comprising:
a memory; and
a system control unit configured to:
capture a moving image to generate moving image data;
record the moving image data to at least a first recording file on a recording medium, wherein when a recording time period of the first recording file reaches a first time, stop recording to the first recording file and start recording to a second recording file; and
display, when the recording time period of the first recording file reaches a second time period shorter than the first time, a notice about recording will be switched from the first recording file to the second recording file before recording is switched.

9. An imaging apparatus comprising:
a memory;
a system control unit configured to:
capture a moving image to generate moving image data;
record the moving image data to a recording file on a first recording medium, wherein when a remaining capacity of the first recording medium becomes less than or equal to a first capacity, stop recording on the first recording medium and start recording on a second recording medium; and
display, when the remaining capacity of the first recording medium becomes less than or equal to a second capacity larger than the first capacity, a notice about recording will be switched from the first recording medium to the second recording medium before recording is switched to the second recording medium.

10. A control method for an imaging apparatus, comprising:
capturing a moving image to generate moving image data;
recording the generated moving image data to at least a first recording file on a recording medium,
wherein when a size of the at least first recording file reaches a first size, stopping recording to the first recording file, and starting recording to a second recording file; and
displaying a r notice that recording will be switched from the first recording file to the second recording file before switching to the a least second recording file when the size of the first recording file reaches a second size smaller than the first size.

11. A control method for an imaging apparatus, comprising:
capturing a moving image to generate moving image data;
recording the generated image data to at least a first recording file on a recording medium, wherein when a recording time period of the first recording file reaches a first time, stopping recording to the first recording file and starting recording to a second recording file; and
displaying a notice about recording will be switched from the first recording file to the second recording file before switching to the second recording file when the recording time period of the first recording file reaches a second time smaller than the first time.

12. A control method for an imaging apparatus comprising:
capturing a moving image to generate moving image data;
recording the generated moving image data to a recording file in a first recording medium, wherein when a remaining capacity of the first recording medium becomes less than or equal to a first capacity, stopping recording to the first recording medium and starting recording to a second recording medium; and
displaying a notice about recording will be switched from the first recording medium to the second recording medium before switching to the second recording medium when the remaining capacity of the first recording medium becomes less than or equal to a second capacity larger than the first capacity.

13. A non-transitory computer-readable recording medium containing a program causing a computer to execute a method, the method comprising:
capturing a moving image to generate moving image data;
recording the generated moving image data to at least a first recording file on a recording medium;
stopping recording to the first recording file and starting recording to a second recording file when a size of the first recording file reaches a first size; and
displaying a notice about recording will be switched from the first recording file to the second recording file before switching to the second recording file when the size of the first recording file reaches a second size smaller than the first size.

14. A non-transitory computer-readable recording medium containing a program causing a computer to execute a method, the method comprising:
capturing a moving image to generate moving image data;
recording the generated moving image data to at least a first recording file on a recording medium, wherein when a recording time period of the first recording file reaches a first time, stopping recording to the first recording file and starting recording to a second recording file; and
displaying a notice about recording will be switched from the first recording file to the second recording file before switching to the second recording file when the recording time period of the first recording file reaches a second time period shorter than the first time period.

15. A non-transitory computer-readable recording medium causing a computer to execute a method, the method comprising:
capturing a moving image to generate moving image data;
recording the generated moving image data to a recording file on a first recording medium, wherein when a remaining capacity of the first recording medium becomes less than or equal to a first capacity, stopping recording to the first recording medium and starting recording to a second recording medium; and
displaying a notice about recording will be switched from the first recording medium to the second recording medium before switching to the second recording medium when the remaining capacity of the first recording medium becomes less than or equal to a second capacity larger than the first capacity.
